(19) United States
(12) Patent Application Publication
(10) Pub. No.: US 2005/0093777 A1
(43) Pub. Date: May 5, 2005

(54) Panel driving apparatus

(76) Inventors: Myoung-Kwan Kim, Seoul (KR); Joon-Koo Kim, Asan-si (KR)

Correspondence Address: MCGUIREWOODS, LLP, 1750 TYSONS BLVD, SUITE 1800, MCLEAN, VA, 22102, US

(21) Appl. No.: 10/959,109

(22) Filed: Oct. 7, 2004

(30) Foreign Application Priority Data
Oct. 30, 2003 (KR) 2003-76195

(51) Int. Cl. G09G 3/28

(52) U.S. Cl. 345/60

(57) ABSTRACT

A panel driving apparatus includes a first subfield data generator which converts input data of an odd frame into subfield data, a second subfield data generator which converts input data of an even frame into subfield data, an adder which adds the subfield data of the odd frame and the subfield data of the even frame, a frame memory which is subject to writing and reading of an output of the adder in response to a second clock, and a buffer memory connected to an output terminal of the frame memory, the buffer memory being subject to writing in response to the second clock and subject to reading in response to a first clock.

### BACKGROUND OF THE INVENTION

This application claims the priority of Korean Patent Application No. 2003-76195, filed on Oct. 30, 2003, in the Korean Intellectual Property Office, the disclosure of which is incorporated herein by reference in its entirety.

1. Field of the Invention

The present invention relates to Plasma Display Panels generally, and more particularly to an apparatus for driving a panel such as a plasma display panel (PDP) which displays an image by applying sustain pulses to an electrode structure forming display cells.

2. Description of the Related Art

FIG. 1 shows the structure of a conventional surface discharge type PDP having a triodate electrode. Referring to FIG. 1, address electrode lines A₁, A₂, . . . , Aₘ, dielectric layers 102 and 110, Y-electrode lines Y₁, . . . , Yₙ, X-electrode lines X₁, . . . , Xₙ, phosphor layers 112, partition walls 114, and a protective layer 104, e.g., a magnesium oxide (MgO) layer, are provided between front and rear glass substrates 100 and 106 of a general surface discharge PDP.

The address electrode lines A₁ through Aₘ are formed on the front surface of the rear glass substrate 106 in a predetermined pattern. A rear dielectric layer 110 is formed on the surface of the rear glass substrate 106 having the address electrode lines A₁ through Aₘ. The partition walls 114 are formed on the front surface of the rear dielectric layer 110 to be parallel to the address electrode lines A₁ through Aₘ. These partition walls 114 define the discharge areas of respective display cells and serve to prevent cross talk between display cells. The phosphor layers 112 are formed between partition walls 114.

The X-electrode lines X₁ through Xₙ and the Y-electrode lines Y₁ through Yₙ are formed on the rear surface of the front glass substrate 100 in a predetermined pattern to be orthogonal to the address electrode lines A₁ through Aₘ. The respective intersections define display cells. Each of the X-electrode lines X₁ through Xₙ may include a transparent electrode line Xₙₐ formed of a transparent conductive material, e.g., indium tin oxide (ITO), and a metal electrode line X_{nb} for increasing conductivity. Each of the Y-electrode lines Y₁ through Yₙ may include a transparent electrode line Yₙₐ formed of a transparent conductive material, e.g., ITO, and a metal electrode line Y_{nb} for increasing conductivity. A front dielectric layer 102 is deposited on the entire rear surface of the front glass substrate 100 having the rear surfaces of the X-electrode lines X₁ through Xₙ and the Y-electrode lines Y₁ through Yₙ. A protective layer 104, e.g., a MgO layer, for protecting the panel 1 against a strong electrical field, is deposited on the entire rear surface of the front dielectric layer 102. A gas for forming plasma is hermetically sealed in a discharge space 108.

In driving such a PDP, a reset step, an address step, and a sustain step are sequentially performed in each subfield. In reset step, charges are uniformized in display cells to be driven. In the address step, a charge state of display cells to be selected and a charge state of display cells to be unselected are set up. In the sustain step, a display discharge is performed in the display cells to be selected. Here, plasma is produced from the plasma forming gas in the display cells where the display discharge is performed. The plasma emits ultraviolet rays exciting the phosphor layers 112 in the display cells, so that light is emitted.

FIG. 2 shows a typical driving apparatus for the PDP 1 shown in FIG. 1. Referring to FIG. 2, the typical driving apparatus for the PDP 1 includes an image processor 200, a logic controller 202, an address driver 206, an X-driver 208, and a Y-driver 204. The image processor 200 converts an external analog image signal into a digital signal to generate an internal image signal composed of, for example, 8-bit red (R) video data, 8-bit green (G) video data, 8-bit blue (B) video data, a clock signal, a horizontal synchronizing signal, and a vertical synchronizing signal. The logic controller 202 generates drive control signals S_{A}, S_{Y}, and S_{X} in response to the internal image signal from the image processor 200. The address driver 206 processes the address signal S_{A} among the drive control signals S_{A}, S_{Y}, and S_{X} output from the logic controller 202 to generate a display data signal and applies the display data signal to address electrode lines. The X-driver processes the X-drive control signal S_{X} among the drive control signals S_{A}, S_{Y}, and S_{X} output from the logic controller 202 and applies the result of processing to X-electrode lines. The Y-driver processes the Y-drive control signal S_{Y} among the drive control signals S_{A}, S_{Y}, and S_{X} output from the logic controller 202 and applies the result of processing to Y-electrode lines.

An address-display separation driving method for the plasma display panel 1 having such a structure is disclosed in U.S. Pat. No. 5,541,618.

FIG. 3 shows a typical address-display separation driving method with respect to Y-electrode lines of the PDP 1 shown in FIG. 1. Referring to FIG. 3, to realize time-division grayscale display, a unit frame may be divided into a predetermined number of subfields, e.g., 8 subfields SF1 through SF8. In addition, the individual subfields SF1 through SF8 are composed of reset periods (not shown), respectively, address periods A1 through A8, respectively, and sustain periods S1 through S8, respectively.

During each of the address periods A1 through A8, display data signals are applied to the address electrode lines A₁ through Aₘ of FIG. 1, and simultaneously, a scan pulse is sequentially applied to the Y-electrode lines Y₁ through Yₙ.

During each of the sustain periods S1 through S8, a sustain pulse is alternately applied to the Y-electrode lines Y₁ through Yₙ and the X-electrode lines X₁ through Xₙ, thereby provoking display discharge in display cells in which wall charges are induced during each of the address periods A1 through A8.

The brightness of the PDP 1 is proportional to the number of sustain pulses during the sustain periods S1 through S8 in a unit frame. When a unit frame forming a single image is expressed by 8 subfields and 256 grayscales, different numbers of sustain pulses may be allocated to the respective 8 subfields at a ratio of 1:2:4:8:16:32:64:128. Brightness corresponding to 133 grayscales can be obtained by addressing cells and sustaining a discharge during a first subfield SF1, a third subfield SF3, and an eighth subfield SF8.

The number of sustain pulses allocated to each subfield can be variably determined depending upon weights, which are applied to the respective subfields according to an automatic power control (APC) level, and can also be variously changed taking account of gamma characteristics or panel characteristics. For example, a grayscale level allocated to a fourth subfield SF4 can be lowered from 8 to 6 while a grayscale level allocated to the eighth subfield SF8 can be increased from 32 to 34. In addition, the number of subfields constituting a single frame can be variously changed according to design specifications.

FIG. 4 is a timing chart showing examples of driving signals used in the PDP 1 shown in FIG. 1. In other words, FIG. 4 illustrates driving signals applied to address electrodes A₁ through Aₘ, common electrodes X, and scan electrodes Y₁ through Yₙ during a single subfield SF in an address display separated (ADS) driving method of an alternating current (AC) PDP. Referring to FIG. 4, the single subfield SF includes a reset period PR, an address period PA, and a sustain period PS.

During the reset period PR, a reset pulse is applied to all of the scan electrodes Y₁ through Yₙ, thereby initializing a state of wall charges in every cell. The reset period PR is provided prior to the address period PA. Since the initialization is performed throughout the PDP 1 during the reset period PR, highly uniform and desirable distribution of wall charges can be obtained. The cells initialized during the reset period PR become have similar wall charge conditions to one another. The reset period is followed by the address period PA. During the address period PA, a bias voltage Vₑ is applied to the common electrode X, and scan and address electrodes corresponding to cells to be displayed are simultaneously turned on to select the cells. Here, V_{A} indicates an address voltage. After the address period PA, a sustain pulse V_{S} is alternately applied to the common electrodes X and the scan electrodes Y₁ through Yₙ during the sustain period PS. During the sustain period PS, a voltage V_{G} of a low level is applied to the address electrodes A₁ through Aₘ.

In a PDP, brightness is controlled according to the number of sustain pulses. As the number of sustain pulses applied during a single subfield or a single TV field increases, brightness also increases.

FIG. 5 is a block diagram of the logic controller 202 shown in FIG. 2. The logic controller 202 includes an address data generator 202a, a scan pulse generator 202b, and a sustain pulse generator 202c. The address data generator 202a receives RGB grayscale data from the image processor 200, converts the RGB grayscale data into subfield data, and outputs the subfield data to the address driver 206. Meanwhile, the scan pulse generator 202b generates scan pulses for each subfield so that subfield information can be written to each scan line. The sustain pulse generator 202c applies sustain pulses alternately to scan electrodes and common electrodes during a sustain period.

With a trend of high definition (HD) in a PDP, an amount of data to be processed within a single TV frame has been increased. For example, an HD PDP needs to simultaneously process at least twice more data than a standard definition (SD) PDP.

A conventional HD PDP uses 6 frame memories to process data since a data processing procedure is divided into three processes for R, G, and B, respectively, and an odd frame and an even frame are separately processed in each process for R, G, or B.

FIG. 6 illustrates actions of two frame memories used when the address data generator 202a shown in FIG. 5 generates subfield data for respective R, G, and B. A first subfield data generator 500 converts input data of an odd frame into subfield data. A second subfield data generator 502 converts input data of an even frame into subfield data. The subfield data of the odd frame and the subfield data of the even frame are separately stored in an A frame memory 508 and a B frame memory 510 via a logic adder 504 and a data buffer 506.

While odd subfield data is written (W) to the A frame memory 508, even subfield data is read (R) from the B frame memory 510. Conversely, while even subfield data is written to the B frame memory 510, odd subfield data is read from the A frame memory 508. Here, the same clock CK1 is used to read data from and write data to the A and B frame memories 508 and 510. Generally, the clock CK1 is the same as a system clock used by the logic controller 202.

### SUMMARY OF THE INVENTION

The present invention provides a panel driving apparatus for rearranging subfield data of an even frame and subfield data of an odd frame using only a single frame memory without using a frame memory toggle method.

In one embodiment, a panel driving apparatus includes a first subfield data generator which converts input data of an odd frame into subfield data. The apparatus further includes a second subfield data generator which converts input data of an even frame into subfield data, and an adder which adds the subfield data of the odd frame and the subfield data of the even frame. The apparatus also includes a frame memory which is subject to writing and reading of an output of the adder in response to a second clock. Further included in the apparatus is a buffer memory which is connected to an output terminal of the frame memory. In the embodiment, the buffer memory is being subject to writing in response to the second clock and subject to reading in response to a first clock.

Preferably, the second clock has a frequency at least twice higher than the first clock.

The input data is RGB video data, and three frame memories and three buffer memories may be provided for the RGB video data, respectively.

### BRIEF DESCRIPTION OF THE DRAWINGS

The above and other features and advantages of the present invention will become more apparent by describing in detail a preferred embodiment thereof with reference to the attached drawings.

FIG. 1 shows a structure of a conventional surface discharge type plasma display panel (PDP) having a triode electrode.

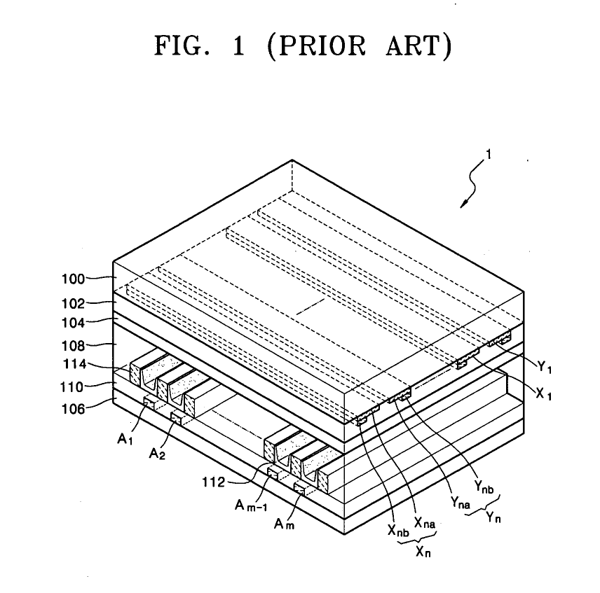

FIG. 2 shows a typical driving apparatus for the PDP shown in FIG. 1.

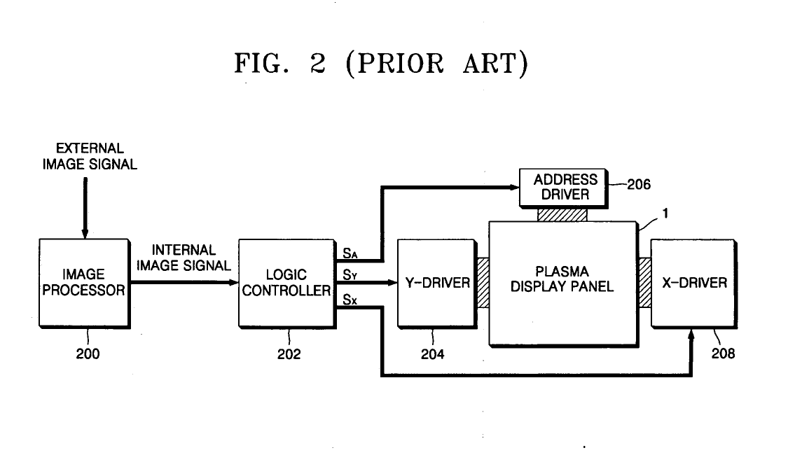

FIG. 3 shows a typical address-display separation driving method with respect to Y-electrode lines of the PDP shown in FIG. 1.

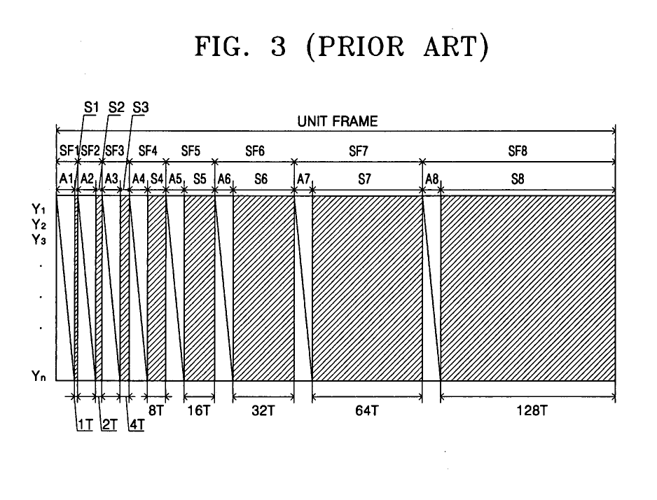

FIG. 4 is a timing chart showing examples of driving signals used in the PDP shown in FIG. 1.

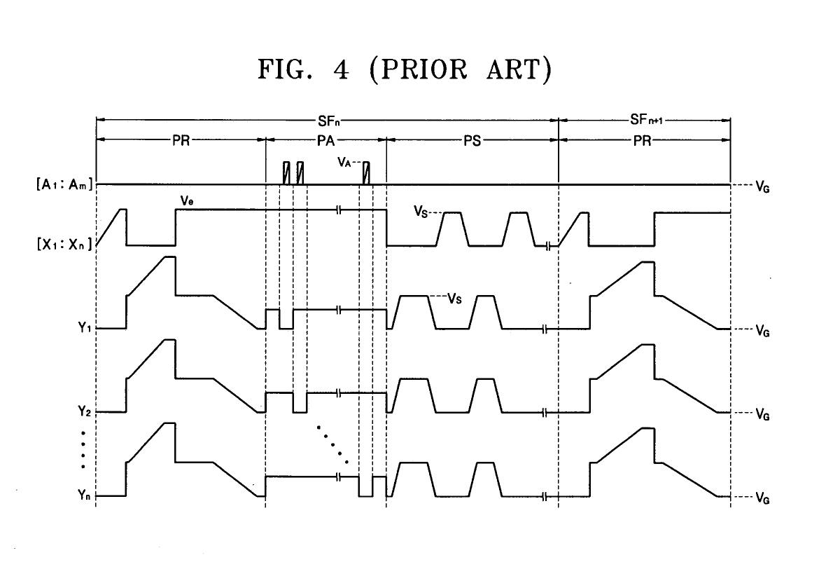

FIG. 5 is a block diagram of an internal structure of the logic controller shown in FIG. 2;

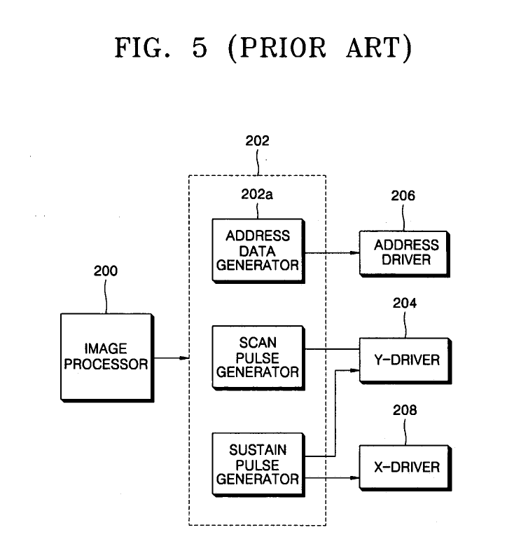

FIG. 6 illustrates a conventional memory structure and operation within an address data generator shown in FIG. 5; and

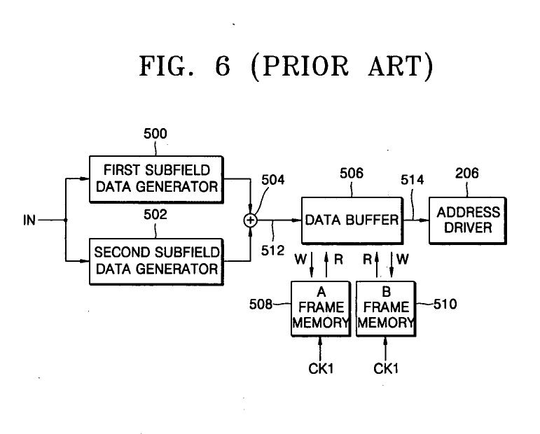

FIG. 7 is a block diagram of an improved panel driving apparatus according to an embodiment of the present invention.

### DETAILED DESCRIPTION OF THE INVENTION

Hereinafter, preferred embodiments of the present invention will be described in detail with reference to the attached drawings.

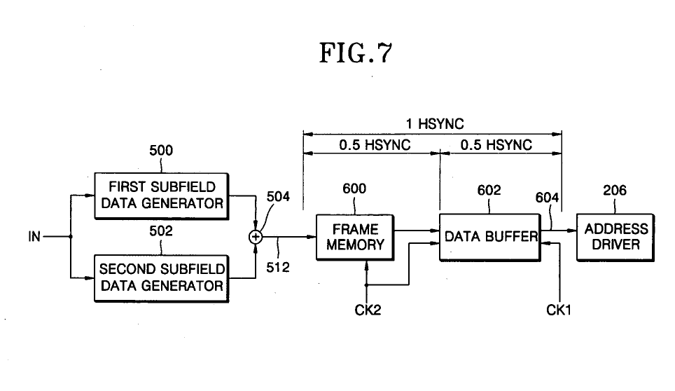

FIG. 7 is a block diagram of a panel driving apparatus according to an embodiment of the present invention. The panel driving apparatus includes a first subfield data generator 500, a second subfield data generator 502, an adder 504, a frame memory 600, a data buffer memory 602, and an address driver 206.

The first subfield data generator 500 converts input data of an odd frame into subfield data. The second subfield data generator 502 converts input data of an even frame into subfield data. The adder 504 adds the subfield data of the odd frame and the subfield data of the even frame and outputs a result of addition (512). The adder 504 may be implemented by an OR gate. The frame memory 600 is subject to writing and reading in response to a second clock CK2 which may have a frequency at least twice higher than a system clock of the panel driving apparatus. The data buffer memory 602 is connected to an output terminal of the frame memory 600. The data buffer memory 602 is subject to writing in response to the second clock CK2 and is subject to reading in response to a first clocks signal CK1 which is the same as the system clock of the panel driving apparatus.

In such structure, odd subfield data output from the first subfield data generator 500 and even subfield data output from the second subfield data generator 502 are written to and read from the single frame memory 600 as follows.

All of the odd subfield data output from the first subfield data generator 500 is written to the frame memory 600. Preferably, a write clock for the frame memory 600, i.e., the second clock CK2 has a frequency at least twice higher than the first clock CK1.

Next, while the even subfield data output from the second subfield data generator 502 is being written to the frame memory 600, the odd subfield data is read from the frame memory 600. The second clock CK2 is also used as a read clock for the frame memory 600.

Reading the odd subfield data from the frame memory 600 and writing the even subfield data to the frame memory 600 should be sequentially continued without overlapping within a single line, i.e., a single horizontal synchronizing (HSYNC) signal. In addition, reading needs to be performed first before writing. Otherwise, even subfield data will overwrite odd subfield data at a memory address before the odd subfield data at the memory address is read.

To prevent overwriting from occurring, data is read from the frame memory 600 within a first half of 1 HSYNC, i.e., a first 0.5 HSYNC, and data is written to the frame memory 600 within a latter half of the 1 HSYNC, i.e., a latter 0.5 HSYNC.

Next, in the same manner, reading even subfield data from the frame memory 600, and writing odd subfield data to the frame memory 600 are sequentially performed with a time difference of 0.5 HSYNC.

When such operation is repeated, even subfield data and odd subfield data can be separately processed using only a single frame memory in a display panel.

The frame memory 600 may be implemented by a double data rate synchronous DRAM. Since both of a clock rising edge and a clock falling edge can be used, writing and reading can be performed at double speed using the same frequency clock as that used in a conventional panel driving apparatus. Accordingly, the first clock CK1 may be used as a write/read clock for the frame memory 600.

In one embodiment, the data buffer memory 602 is connected to an output terminal of the frame memory 600. The data buffer memory 602 is subject to writing in response to the second clock CK2 and is subject to reading in response to the first clock CK1. Here, the first clock CK1 is the same as the system clock of the panel driving apparatus. The data buffer memory 602 restores a data clock that was changed to use the single frame memory 600.

Meanwhile, input data IN to the panel driving apparatus shown in FIG. 7 may be RGB video data. In this situation, the first subfield data generator 500 and the second subfield data generator 502 may convert the RGB video data into subfield data for respective R, G, and B. In addition, three frame memories 600 may be disposed at R, G, and B video data processing paths, respectively.

In a conventional RGB data processing procedure, two frame memories are used in a toggle method so that one type of subfield data is written to the one frame memory while another type of subfield data is read from the other frame memory. However, in the present invention, a single frame memory is used, instead of using two frame memories having a large capacity. Accordingly, the present invention may reduce the manufacturing cost of a display panel.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A panel driving apparatus, comprising:
a first subfield data generator converting input data of an odd frame into subfield data;
a second subfield data generator which converts input data of an even frame into subfield data;
an adder adding the subfield data of the odd frame and the subfield data of the even frame;
a frame memory that is subject to writing and reading of an output of the adder in response to a second clock; and
a buffer memory connected to an output terminal of the frame memory, the buffer memory being subject to writing in response to the second clock and subject to reading in response to a first clock.

2. The panel driving apparatus of claim 1, wherein the second clock has a frequency at least twice higher than the first clock.

3. The panel driving apparatus of claim 1, wherein the input data is RGB video data, and three frame memories and three buffer memories are provided for the RGB video data, respectively.

4. The panel driving apparatus of claim 1, wherein the frame memory is a double data rate synchronous DRAM.

5. A method for driving a plasma display panel using a single frame memory, comprising:
writing odd subfield data output from a first subfield generator into a frame memory;
writing even subfield data output from a second subfield generator into the frame memory; and
simultaneously reading the odd subfield data from the frame memory as the even subfield data is written to the frame memory.

6. The method of claim 5, further comprising:
sequentially continuing the reading of odd subfield data from the frame memory and the writing the even subfield data to the frame memory without overlap.

7. The method of claim 5, wherein reading the odd subfield data is performed before writing the even subfield data.

8. The method of claim 5, further comprising:
simultaneously reading the even subfield data while writing the odd subfield data.

9. The method of claim 5, wherein the writing of odd subfield data and the reading of even subfield data is performed at double speed.

10. The method of claim 5, wherein the simultaneous reading eliminates a single frame toggle method.
